(19) United States
(12) Patent Application Publication
(10) Pub. No.: US 2002/0073790 A1
(43) Pub. Date: Jun. 20, 2002

(54) Transmission-drive unit, in particular for a seat adjustment or servo steering with at least one supporting element

(76) Inventors: Martin Wiesler, Baden/neuweier (DE); Manfred Winter, Lichtenau (DE); Willi Schmidt, Stuttensee-Buechig (DE); Gilles Peter, Haguenau (FR); Andreas Lienig, Buehl (DE)

Correspondence Address: STRIKER, STRIKER & STENBY, 103 East Neck Road, Huntington, NY, 11743, US

(21) Appl. No.: 10/025,009

(22) Filed: Dec. 19, 2001

(30) Foreign Application Priority Data
Dec. 19, 2000 (DE) 100 63 391.9
Aug. 8, 2001 (DE) 101 39 051.3

(51) Int. Cl. F16H 25/20

(52) U.S. Cl. 74/89.34

(57) ABSTRACT

A transmission-drive unit for a seat adjustment or a servo steering has a transmission housing; a driven shaft extending outwardly beyond the transmission housing; a driven wheel non rotatably arranged on the driven shaft; a supporting element which directly at least partially surrounds the driven shaft so that the driven wheel is supported against the supporting element by axial force action from outside.

### BACKGROUND OF THE INVENTION

The present invention relates to a transmission-drive unit, in particular for a seat adjustment or servo steering with at least one supporting element.

European patent document EP 0 759 734 A2 discloses a device for adjusting a seat in a motor vehicle, which can receive considerably greater forces than in a normal operation, caused for example by a traffic accident. It is here important that the driver seat remains firmly connected with the body, to guarantee the operation of the corresponding protective features for the vehicle occupant (safety belt, airbag). A threaded nut receives a threaded spindle and is fixedly connected with the body. The threaded spindle is driven through a screw transmission from an electric motor which in turn is fixedly connected with the seat. The transmission housing of the screw transmission is composed of synthetic plastic and connected via a further housing part with the drive motor. When the drive motor is actuated, the threaded spindle is rotated and displaces the transmission housing including the drive motor and the seat relative to the threaded nut. For preventing the release of the transmission housing from the threaded spindle in the event of an accident, an additional metallic, U-shaped supporting part is provided. It connects the transmission housing through a hinge pin with the drive motor and thereby with the seat. The transmission housing of synthetic plastic can not withstand high forces, and therefore it is held with an additional threaded nut by the metallic supporting part.

The disadvantage of this construction is that additionally to the complete transmission housing, an expensive supporting construction is required which increases the number of the components and occupies additional spaces.

### SUMMARY OF THE INVENTION

Accordingly, it is an object of the present invention to provide a transmission unit, in particular for a seat adjustment or servo steering with at least one supporting element, which avoids the disadvantages of the prior art.

In keeping with these objects and with others which will become apparent hereinafter, one feature of the present invention resides, briefly stated in a transmission-drive unit for a seat adjustment or a servo steering, comprising a transmission housing; a driven shaft extending outwardly beyond said transmission housing; a driven wheel non rotatably arranged on said driven shaft; a supporting element which directly at least partially surrounds said driven shaft so that said driven wheel is supported against said supporting element by axial force action from outside

When the transmission-drive unit is designed in accordance with the present invention, it has the advantage that the driven wheel in the event of increased force action is supported along the driven shaft, for example in the event of a traffic accident, directly on a supporting element. Therefore it is especially favorable that not the complete transmission housing must be additionally supported, but only the driven wheel must be supported directly against a supporting element. This can be realized with rather smaller expenses.

With the inventive device an impact protection is integrated in a simple manner in the transmission-drive unit. Thereby the seat in the event of a traffic accident remains reliably in its position in the vehicle.

When the driven shaft, at least partially, is directly surrounded by the supporting element, in other words without further components between the driven shaft and the supporting element, the supporting element takes up in immediate radial vicinity to the drilling shaft, forces in a longitudinal direction. Thereby sharing stresses inside the driven wheel are minimized and therefore a destruction of the driven wheel is prevented.

Advantageously the supporting element is arranged between the driven wheel at the inner side of the transmission housing. Therefore the forces are transmitted via the end side of the driven wheel radially in immediate vicinity to the driven shaft to the driven element, and further transmitted to the stabile transmission housing connected with the drive motor. Alternatively, the force of the supporting element can be also transmitted to a backing which is fixedly connected with the whole transmission housing. Thereby a uniform force transmission from the transmission housing is provided, for example to a predetermined part of the seat.

The support element can be formed as a part of a wall of the transmission housing. In this case it occupies an especially small structural space. The supporting element can have a ring nut which passes in a corresponding counter formation of the transmission housing.

It is advantageous when the driven wheel is formed on a part of the driven shaft provided with a bead or a thread, by an injection molding process. Thereby a good axial fixing of the driven wheel relative to the driven shaft is guaranteed. Since the driven shaft is produced from a threaded spindle, the threaded portion for the driven wheel can be formed in a simple manner, by forming the thread in the adjoining regions by turning.

When the thread of the driven shaft has at this location a greater diameter than the inner diameter of the supporting element which at least partially surrounds the driven shaft, the action lines of the pulling force acting on the drilling shaft and the counter force transmitted to the drilling shaft approach one another. For example both forces are located on an action line. Thereby the axial sheering stress of the driven wheel is minimized or suppressed and therefore damaged to the same is prevented. As a result a higher axial forces, for example in the case of an accident are taken up.

Under normal operational conditions of the adjusting process the driven wheel does not contact the supporting element. Thereby a friction losses can be prevented despite additional impact protection.

In an alternative embodiment the supporting element is located in advantageous manner inside the driven wheel. For this purpose the supporting element first is fixed at least axially on the driven shaft, and then injection molded around the driven wheel. Thereby the driven wheel is supported directly on the supporting element, and therefore the possible axial force take up of the driven wheel is significantly increased. This embodiment does not require any additional space.

It is especially advantageous when the supporting element is mounted form-lockingly on the driven shaft. It is advantageous when the supporting element is therefore formed as a ring or a disc with an inner thread, which is screwed on an outer thread of the driven shaft. This connection is very cost favorable since the driven shaft in a spindle drive is formed as a rule as a throughgoing threaded spindle which in individual regions is machined by turning for bearings. For this reasons the driven shaft in the region of the supporting element has an outer thread.

When a speed nut is used as a supporting element, it can be easily moved on a driven shaft with a smooth surface. The inner edges of the speed nut are fixed in direction of the force action on the surface of the driven shaft. For higher strength requirements several discs can be arranged one behind the other. Therefore the injection molded driven wheel engages the discs in the intervals between the speed nut.

The outer diameter of the supporting element can be greater than the inner diameter of the running disc, and in this case the driven wheel in normal adjustment operation is axially guided over a collar on the driven wheel, so that the action lines of the axial reacting forces of the driven shaft and the transmission housing coincide with one another. Thereby an axial sheering of the driven wheel is prevented, and in the case of the destruction of the driven wheel, falling of the driven shaft from the transmission housing is prevented, since the supporting ring overlaps with the running disc.

For mounting of the supporting element, in particular with the arrangement between the driven wheel and the inner wall of the housing or as a part of the housing wall, it is advantageous when the supporting element is composed of several parts. For example in this case a first half shell of the supporting element is inserted before the mounting of the spindle and a second half shell is introduced after the same, so that the both parts completely surround the driven shaft. With the multi-part construction in this case a peripherally closed supporting surface is obtained. Alternatively, a part of the supporting element can be removed, when the maximum occurring crash forces allow the same.

The driven shaft can be produced especially favorably in a process with the use of a synthetic plastic. The construction as a screw wheel with a corresponding screw on the motor shaft guarantees in an advantageous manner a self-locking of the transmission with favorable transmission ratio and low weight.

The safety of the passenger occupants increases since in the event of destruction of the driven shaft composed in some cases of plastic, an end of the drilling shaft is held inside the transmission housing produced for example of metal. Thereby it is prevented that the seat is lost from the body in the event of an accident.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### DESCRIPTION OF THE DRAWINGS

FIG. 1 is a view showing a seat adjustment device in accordance with one embodiment;

FIG. 2 is a view showing a force application in a screw wheel in a known transmission-drive unit;

FIG. 3 is a view showing a transmission-drive means in accordance with the present invention in a cross-section;

FIGS. 4 and 5 are views showing different embodiments of a supporting element in detail; and

FIGS. 6 and 7 show two further embodiments in a cross-section.

### DESCRIPTION OF THE PREFERRED EMBODIMENTS

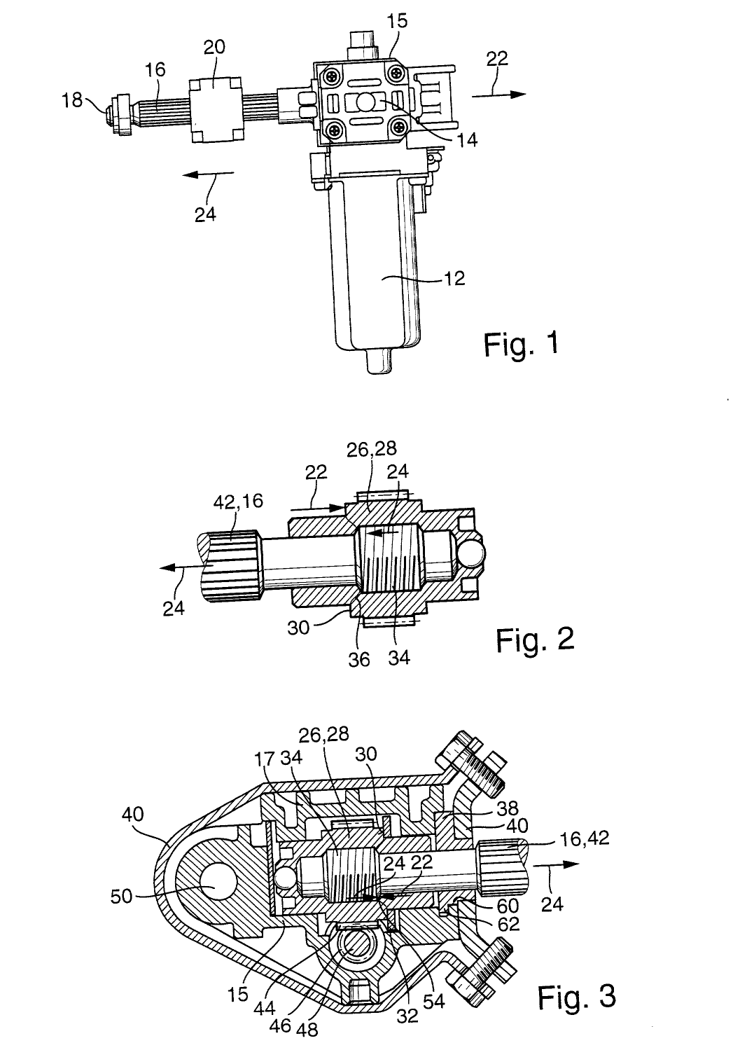

FIG. 1 shows an embodiment of a transmission-drive unit in accordance with the present invention. It includes an electric motor 12 which drives a spindle 16 through a screw transmission 14. The spindle 16 extends outwardly beyond a transmission housing 15 of the screw transmission 14. The electric motor 12 with a transmission housing 15 which directly encloses the same are mounted on one side, while the outwardly extending end 18 and the spindle 16 is mounted on the other side for example of a vehicle seat. A threaded nut 20 is located on the spindle 16 and is fixedly mounted on a body bottom. Alternatively, it is also possible to fix the threaded nut 20 on the seat and to fix the spindle 16, the transmission housing 15, the electric motor 12 on the body, or both the threaded nut 20 as well as the electric motor 12 with the transmission housing 15 on a kinematic system of a seat which is integrated in the vehicle seat.

When the vehicle in FIG. 1 moves for example to the right, and the vehicle is abruptly stopped by a traffic accident, an inertia force 22 acts on the transmission housing 15 which is mounted on the seat to the right. The spindle 16 is fixedly held by the threaded nut 20, so that a corresponding pulling force 24 acts as an opposite force on the spindle 16. The weakest point in the thusly caused force flow between the vehicle seat and the body is the screw transmission 14.

FIG. 2 shows a driven wheel 23 of a known transmission drive unit 10, formed as a screw wheel 26, with forces acting in the event of an accident. The screw wheel 26 is composed of synthetic plastic and injection molded over a thread 34 formed on the spindle 16 in an injection molding process. The screw wheel 26 on its collar 30 is axially guided by means of a running disc 32 which is supported in the transmission housing 15, which is not shown here in detail. Thereby the inertia force 22 is transmitted from the seat through the transmission housing 15 to the collar 30 of the screw wheel 26. The oppositely acting pulling force 24 engages the axial end surface between the thread 34 of the spindle 16 and the screw wheel 26.

Because of the different peripheral regions of the forces 22 and 24 which act on the screw shaft 26, a sheer stress is caused on the screw wheel 26, which leads to its breaking along the break course 36. As a result the spindle 16 is cracked from the transmission housing 15 and the seat in the event of an accident is lost from the body. The invention therefore relies on the understanding that the sheer stresses of the screw wheel 26 caused by different radii of the engaging points of the both forces 22 and 24 must be prevented.

In the embodiment of FIG. 3 a supporting element 38 is arranged between the driven wheel 28 formed as a screw wheel 26, and a packing 40 which fixedly surrounds the transmission housing 15. The driven wheel 28 is injection molded here also on the thread 34 of a driven shaft 42 formed as a spindle 16. The driven wheel 28 engages through teeth 48 with a screw 26 which is arranged on an armature shaft 48 of the electric motor 12. The driven wheel 28 has a collar 30, with an end side, on which the driven wheel 28 is axially guided by a running disc 32 of metal. The running disc 32 is supported in the transmission housing 15 which is surrounded by the packing 40.

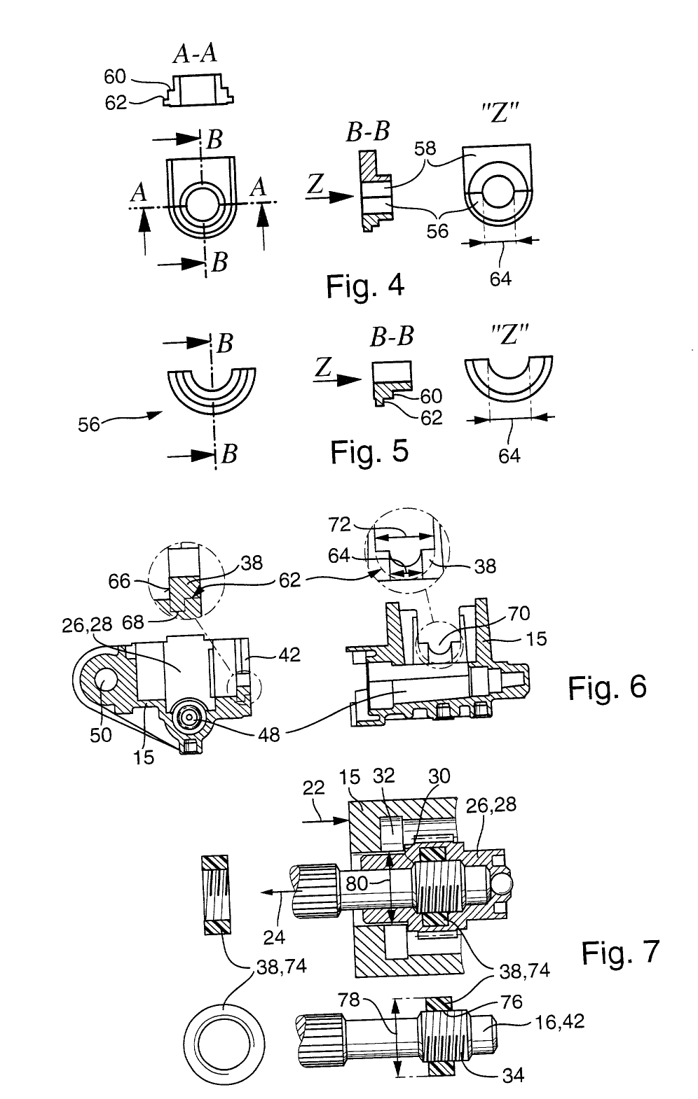

The transmission housing 15 has a cover 17 and an eye 50 which serves for mounting of the transmission housing 15 on the vehicle seat or on the body by a pin. The supporting element 38 has two parts which together completely surround the driven shaft 32 over 360°, as shown in FIG. 4. The supporting element 38 is joined to the transmission housing 15 and the packing 40 by two molded ring grooves 60 and 62.

In normal adjustment operation the supporting element 38 does not contact the driven wheel 28 to avoid friction losses. In the event of an excessive force action 24 of the driven shaft 42 (for example in the event of a crash) the force 24 of the driven shaft 28 engages in the region of the end surface 54 of the thread 34. The opposite force 22 is transmitted on the one hand directly to the screw wheel 28 and on the other hand to the supporting element 38 which receives the crash force 24. In this case the driven wheel 28 expands since it is composed of plastic so far that it contacts the supporting element 38. Since the supporting element 38 extends radially directly to the outer diameter of the driven shaft 22, the action lines of the forces 24 and 22 overlap. Thereby the occurance of sheering forces in the driven wheel 28 is prevented.

FIG. 4 shows a supporting element 38 composed of two parts, as used for example in the embodiment of FIG. 3. The supporting elements 38 is composed of a lower half shell 56 and an upper half shell 58 which together surround the driven shaft directly at 42. For mounting first the lower half shell 56 is introduced into the known transmission housing 15, then the driven shaft 42 is inserted, and thereafter the upper half shell 58 is inserted, and subsequently the transmission housing 15 is provided with a cover 17 and the packing 40 is mounted.

The supporting element 48 has two ring-shaped grooves 60 and 62, with which it is supported against the packing 40 and the transmission housing 15. Thereby the inertia force 22 in the event of a crash is transmitted from the seat through the packing 40 and the housing 15, over the supporting element 38 to the driven shaft 28, which in the case of high load expands axially so that it contacts the supporting element 38. The inner diameter 64 of the supporting element 38 is dimensioned so that it maximally overlap the end surface 66 of the supporting wheel 28 without contacting the driven shaft 42.

Alternatively, the upper half shell 58 can be dispensed with, so that the supporting element 38 in FIG. 4 is composed only of a lower half shell 56. It surrounds the driven shaft 42 only over its half and in some cases is inserted through the ring-shaped grooves 60 and 62 in the packing 40 and/or the transmission housing 15.

A further embodiment of the invention is shown in FIG. 7. The supporting element 38 is here formed as a ring-shaped disc 74 with an inner thread 76, which is screwed before injection molding of the driven shaft 28 on the thread 34 of the driven shaft 42 which is formed as a spindle 16. The outer diameter 78 of the ring-shaped disc 34 is greater than the inner diameter 80 of the running disc 32 supported in the transmission housing 15. The end surfaces of the supporting element 38 and the running disc 32 overlap one another, whereby the force flux between these two surfaces extends through the parts of the driven shaft 28 on an action line. The force 22 which acts in the event of an accident is transmitted through the transmission housing 15 to the running disc 32 and acts on the collar 30 on the driven wheel 28. The driven wheel 28 is supported on the supporting element 38 which is connected via thread flanks in a force-locking manner with a driven shaft 42, on which thereby the pulling force 24 acts as a counter force.

Due to the overlapping of the outer diameter 78 with the inner diameter 80, the both forces 32 and 34 engage first approximately on the same action line. Therefore in the driven wheel 28 no sheering forces occur and thereby the loading of the driven wheel 28 is considerably reduced. In the case of a destruction of the driven shaft 28, the supporting element 38 is held by the overlapping of the same with the running disc 32 in the transmission housing 15. Thereby the vehicle seat remains anchored in its original position also in the event of an accident.

Alternatively to the embodiment as a threaded nut, the driven element in accordance with another embodiment can be formed as a speed nut. The speed nut or disc is displaced opposite to the crush force direction 24 on the driven shaft. Therefore its inner edge is fixed on the smooth surface of the driven shaft.

While the above described embodiments deal with the seat adjustment device, it can be also used for adjustment movements, such as for example a steering booster in which during occurrence of high forces it must be prevented that the driven shaft 28 is lost from the transmission housing 15. A spindle motor can be advantageously utilized, with which the screw wheels 26, 28 are provided with an inner thread in which the spindle 16 is moved axially. Also, a combination of the individual features in different embodiments of the inventive transmission of the transmission-drive unit can be realized in accordance with the present invention.

It will be understood that each of the elements described above, or two or more together, may also find a useful application in other types of constructions differing from the types described above.

While the invention has been illustrated and described as embodied in transmission-drive unit, in particular for a seat adjustment or servo steering with at least one supporting element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A transmission-drive unit for a seat adjustment or a servo steering, comprising a transmission housing; a driven shaft extending outwardly beyond said transmission housing; a driven wheel non rotatably arranged on said driven shaft; a supporting element which directly at least partially surrounds said driven shaft so that said driven wheel is supported against said supporting element by axial force action from outside.

2. A transmission-drive unit as defined in claim 1, wherein said supporting element is arranged between said driven wheel and an inner side of said transmission housing.

3. A transmission-drive unit as defined in claim 1; and further comprising a packing which surrounds said transmission housing, said supporting element being arranged between said driven wheel and said packing.

4. A transmission-drive unit as defined in claim 1, wherein said transmission housing has a housing wall, said supporting element being formed as a part of said housing wall.

5. A transmission-drive unit as defined in claim 1, wherein said driven shaft has a bead which is engaged by said driven wheel and which has an outer diameter greater than an inner diameter of said supporting element.

6. A transmission-drive unit as defined in claim 5, wherein said bead is formed as a thread.

7. A transmission-drive unit as defined in claim 1, wherein said supporting element is arranged at a distance from said driven wheel, which distance is reduced with growing axial force action.

8. A transmission-drive unit as defined in claim 1, wherein said supporting element is fixed at least axially on said driven shaft and said driven wheel being formed as an injection molded part which surrounds said supporting element.

9. A transmission-drive unit as defined in claim 8, wherein said supporting element is formed as a ring arranged form-lockingly on said driven shaft.

10. A transmission-drive unit as defined in claim 9, wherein said supporting element is form lockingly arranged on said driven shaft through a thread.

11. A transmission-drive unit as defined in claim 1, wherein said supporting element is formed as a speed nut with an inner edge supported on an outer surface of said driven shaft.

12. A transmission-drive unit as defined in claim 1, wherein said driven wheel has a collar for guiding by a running disc supported in said transmission housing, said supporting element having an outer diameter which is greater than an inner diameter of said running disc.

13. A transmission-drive unit as defined in claim 1, wherein said supporting element is composed of a plurality of parts.

14. A transmission-drive unit as defined in claim 1, wherein said supporting element is composed of two parts.

15. A transmission-drive unit as defined in claim 1, wherein said driven wheel is formed as a screw wheel of synthetic plastic.
